(19) United States
(12) Patent Application Publication
(10) Pub. No.: US 2009/0284959 A1
(43) Pub. Date: Nov. 19, 2009

(54) Transparent illustrations imprinted on solar panel

(75) Inventors: Yi Xu, Richmond Hill (CA); Yechen Xu, Richmond Hill (CA)

Correspondence Address: Yi Xu, 10 Wellspring Ave, Richmond Hill, ON, L4E 4Z6, CA

(73) Assignees: Yi Xu, Richmond Hill (CA); Yechen Xu, Richmond Hill (CA)

(21) Appl. No.: 12/213,125

(22) Filed: Jun. 16, 2008

(30) Foreign Application Priority Data
May 14, 2008 (CA) 2,631,238

(51) Int. Cl. F21L 4/00

(52) U.S. Cl. 362/157

(57) ABSTRACT

The present invention relates to solar lighting device, in particular, an illuminating solar display panel comprising display of a transparent illustration on the solar panel. The present invention has dual functional abilities of collecting solar power as a power supply unit and present illuminating illustration as a display unit, whereby an illustration is cutout from the dark coloured material layers of the power supply panel creating a transparent illustration; thereby, light can enter from behind the panel and create an illuminating effect to the illustration. Instead of two separate components, compromise of solar panel(s) and illuminating display unit, the current invention combines two separate units into one independent power efficient illuminating solar display apparatus.

### FIELD OF INVENTION

The present invention relates to solar lighting device, in particular, a solar powered illuminating display panel comprising display of a transparent illustration on the solar panel, whereby the solar display panel collects and converts solar power to electric power needed to illuminate the transparent illustration displayed on the same panel.

### BACKGROUND OF THE INVENTION

Renewable power source, in particular solar energy, has been widely used in powering small lighting devices. In prior arts, a solar panel is commonly used as a power supply unit, a separate apparatus that converts solar energy into electric energy, which provides electric power in the illumination of signs or light at night.

In WO/2003/010738 and U.S. Ser. No. 11/481,301, the lighting device is composed of two separate components, an illuminating unit and a power supply unit. The illuminating unit requires a solar panel to be mounted thereon in order to power the displayed pattern. The lighting device requires additional space for installation and the design appears bulky and unpleasing to the eye. Further, the use of two separate components has higher manufacturing cost which leads to higher cost for the consumers.

In WO/2008/005582, US2007/016846, the solar panels are mounted across a securely attached board, and plastic illustration can be inserted into the board channels. This lighting device limits the size of displayed patterns, as it must fit into the attached board; this in return limits the usage of the illuminating display to small size lighting devices. Similar to all prior arts relating the art, this solar lighting device uses solar panel with a solo purpose of supplying sufficient energy to illuminate display unit as an external power supply.

### SUMMARY OF THE INVENTION

Solar energy collector, such as solar panel, has been limited to its use as an independent power supply unit that converts solar power into electric energy, thereby illuminating a separate display unit during night through a rechargeable power source. As demonstrated in prior arts, to illuminate signs or any display unit, a solar panel is visible as a connecting part or a separation unit in the prior arts.

The innovation behind current invention is its dual functional abilities of collecting solar power as a power supply unit and present illuminating illustration as a display unit. Instead of two separate components, compromise of solar panel(s) and illuminating display unit, the current invention combines two separate units into one apparatus. The invention relies on the photovoltaic molecule or photovoltaic array on the power supply panel to collect solar power and convert it into electric power used to illuminate transparent illustration displayed on the same panel.

This invention is an innovative reconstruction of the solar panel that incorporates the concept of displaying illustration through contrast of colour and illustration transparency. During the day, the illustration is shown through colour contrast when the designed illustration is cutout from the dark coloured material layers of the power supply panel. During the night, light can enter from behind the panel through the transparent illustration, thereby creating an illuminating effect to the illustration. The invention improves on the prior arts by providing multifunctional abilities to a solar illuminating device as one single apparatus, whereby the display unit becomes a self-sufficient power supply unit without the need for a separate or connecting power supply unit.

This invention will eliminate unnecessary usage of materials in the making of plastic numerals, letters or other characters, as mentioned in prior arts; thereby, decrease production and unit cost. The invention will provide mobility and installation convenience because it requires less space and installation location is not limited due to excessive part and size as in prior arts. Further, the invention is more appealing in comparison to prior arts, as it appears like any other display panel without the visible bulkiness of solar panels. Moreover, the invention has the ability for diverse usage to incorporate illustrations of various sizes upon request, whereby the larger sized illustration can be displayed through solar powered display array and smaller sized illustrations can be display on a single solar powered display panel.

### BRIEF DESCRIPTION OF THE DRAWINGS

In order to understand and show how the invention incorporate display unit and power supply unit into a single apparatus, whereby the power supply unit, commonly known as solar panel, illustrates transparent illustrations on the surface of solar power supply unit, FIG. 1 illustrates the invention and its functionality through a three-dimensional front view; FIG. 2 exemplifies the invention through directional views and dissect analysis of the invention material assembly.

FIG. 1. Illustration of the solar powered illuminating display unit in a three-dimensional view

1. Transparent illustration, including numbers, alphabets and custom characters.

2. Light source

3. Light sensitive power switch

4. Electric rechargeable power source

FIG. 2. Assembly illustration of the invention in three directional view and a dissect illustration of the invention material assembly

1. Transparent surface, such as glass, fibreglass and acrylic glass.

2. Front electrode/metallic conductor strips

3. Anti reflective coating

4. Photovoltaic molecule or photovoltaic array

5. Back electrode/positive charged conductors

### DETAILED DESCRIPTION OF THE DRAWINGS

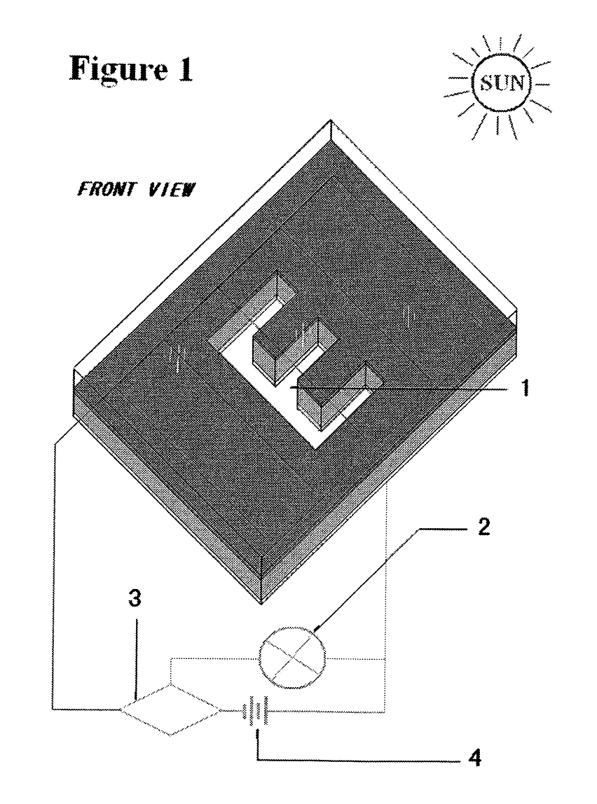

Referring to FIG. 1, there is an illustration of the described invention illustrating the exposure of the designed illustration on the power supply panel. In FIG. 1, similar to solar panel, the invention relies on photovoltaic molecule or photovoltaic array to collect and convert solar power to electric power that is to be stored in a rechargeable power source 4. A light sensitive switch 3 automatically controls the brightness of the light source 2. The light source 2 illuminates the transparent illustration 1 from behind the panel during the night. The colour contrast between the clear transparent illustration and the dark coloured material layers of the power supply panel makes the illustration visible during the day, and allows illumination of the illustration at night. Furthermore, the colour of the illustration can vary with the use of various coloured light source.

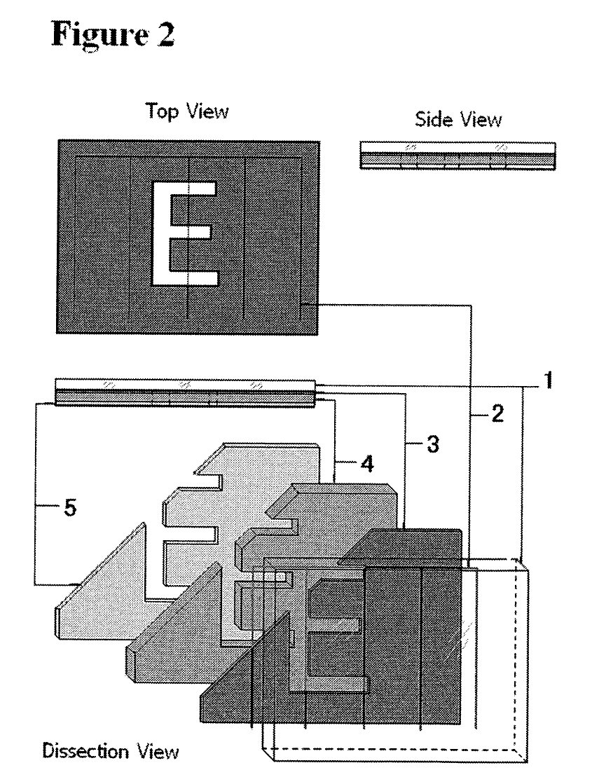

In order to achieve the required effect of solar power collection and displaying illustration, FIG. 2 illustrates the assembly of the invention through three direction views and a dissect analysis to present an overall understanding of the uniqueness of the said invention, whereby the solar panel is also the display panel with ability to collect solar power and display illuminating illustration at night. Similar to the components of a solar panel, the top layer 1, is a transparent surface made from materials comprising plastic, glass, fibreglass and acrylic glass; the second layer 2 in FIG. 2 is the front electrode that collects and transfer electric charge to a rechargeable battery. Layers 3, 4, and 5, anti-reflective coating, photovoltaic modules or photovoltaic array and back electrode in that respective, which has corresponding evaded illustration that allows external light to enter from behind, whereby illuminating the illustration at night while collecting solar energy during the day.

Various changes and modifications can be made to improve the current invention without departing from the scope of the invention as defined in claims. The photovoltaic modules 4 in FIG. 2 commonly comprises silicon can be replaced by flexible thin-film modules and rigid thin film modules, which can be directly laminated on the back of the transparent surface 1. Further, to decrease production cost, the anti-reflective coating 3 in FIG. 2 can be eliminated if the photovoltaic modules 4 consists of high anti-reflective ability; the front electrode 2 can also be eliminated if the transparent surface 1 can conduct electricity; and if the back electrode 5 is a transparent conductor, the need for evading an illustration on the material can be eliminated.

1. A solar powered illuminating display panel comprising a transparent illustration on the power supply unit; wherein:
said power supply unit comprises at least one solar panel; and
said transparent illustrations comprises numerals, alphabets, custom design characters and images;

2. A solar powered illuminating display panel of claim 1 wherein said power supply unit means for supplying operational power to illuminate the said transparent illustration;

3. A solar powered illuminating display panel of claim 1 wherein said power supply unit is also the display panel of the transparent illustration;

4. The transparent illustration of claim 1 means for visibility of the illustration on the said powered supply unit;

5. A solar powered illuminating display panel of claim 1 wherein said power supply unit further comprises corresponding evasion of the illustration on the material layers of the panel;

6. The use of the solar powered illuminating display unit as defined in any one of claims 1-5.
